(19) United States
(12) Patent Application Publication
(10) Pub. No.: US 2009/0307292 A1
(43) Pub. Date: Dec. 10, 2009

(54) DYNAMICALLY CHANGING A GARBAGE COLLECTOR IN A MANAGED RUNTIME SYSTEM

(76) Inventors: Xiaofeng Li, Beijing (CN); Ming Wu, Beijing (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/442,940

(22) PCT Filed: Sep. 26, 2006
(86) PCT No.: PCT/CN06/02528

§ 371 Date: Jul. 27, 2009

(51) Int. Cl. G06F 12/00; G06F 17/30

(52) U.S. Cl. 707/206; 707/204; 707/E17.005

(57) ABSTRACT

Machine-readable media, methods, and apparatus are described to dynamically change a garbage collector in a managed runtime system (1022). In some embodiments, a first garbage collector is loaded into the managed runtime system (1022) during a runtime stage of the managed runtime system (1022). The first garbage collector is further activated to manage a heap organization (203) of the managed runtime system (1022) in place of a second garbage collector of the managed runtime system (1022) during the runtime stage.

### BACKGROUND

Garbage collection (GC) technology has been widely used in managed runtime systems, such as JAVA virtual machine (JVM) and Common Language Runtime (CLR). Usually, a garbage collector, as an executable binary file, is (inked statically or dynamically into the system during an initialization stage of the system. However, once the garbage collector is linked, it is typically unchangeable during a runtime stage of the system until restarting the system.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing platform including a managed runtime system.

FIG. 2 illustrates an embodiment of the managed runtime system.

FIGS. 3-5 illustrate an embodiment of a method of dynamically changing an old garbage collector in the managed runtime system.

### DETAILED DESCRIPTION OF THE PREFERRED EMBODIMENTS

The following description describes techniques for dynamically changing a garbage collector in a managed runtime system. In the following description, numerous specific details such as logic implementations, pseudo-code, methods to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

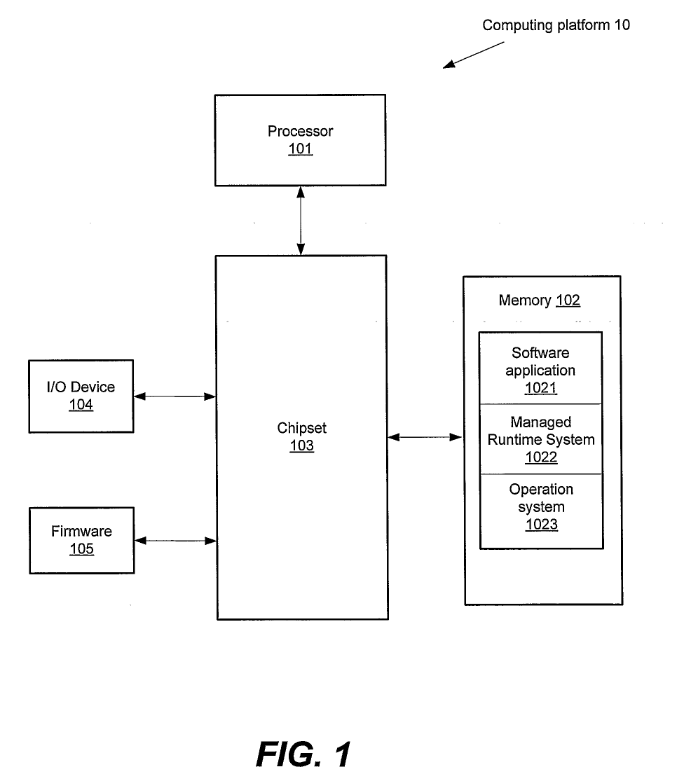

FIG. 1 shows an embodiment of a computing platform 10 comprising a managed runtime system. Examples for the computing platform 10 may include a personal computer, a workstation, a server computer, a personal digital assistant (PDA), a mobile telephone, a game console, and possibly other devices for transceiving and processing data.

The computing platform 10 may comprise one or more processors 101, memory 102, chipset 103, I/O devices 104, a firmware 105 and possibly other components. The one or more processors 101 may be communicatively coupled to various components (e.g., the chipset 103) via one or more buses such as a processor bus. The processors 101 may be implemented as an integrated circuit (IC) with one or more processing cores that may execute codes under a suitable architecture, for example, including Intel® Xeon™, Intel® Pentium™, Intel® Itanium™ architectures, available from Intel Corporation of Santa Clara, Calif.

The memory 102 may store instructions and data in the form of a software application 1021, a managed runtime system 1022 and an operation system 1023. Examples for the memory 102 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

The software application 1021 may be input from any suitable devices, such as the I/O devices 104. In other embodiments, the software applications may be generated by other components within the computing platform 10. Examples for the software application 1021 may comprise JAVA applications (e.g., JAVA bytecodes), .NET application (e.g., .NET CLI bytecodes), and applications compiled from or written in possibly other programming languages (e.g., Smalltalk, Ruby).

The managed runtime system 1022 may run above the operating system 1023 to execute the software application 1021. Examples for the manage runtime system 1022 may comprise a JAVA virtual machine from Sun Microsystems Inc., Mountain View, Calif., and a .NET virtual machine available from Microsoft® Corporation, Redmond, Wash.

The operation system 1023 may include, but is not limited to, different versions of Linux®, Microsoft® Windows®, and real time operating systems such as VxWorks®, etc.

In an embodiment, the chipset 103 may provide one or more communicative paths among the one or more processors 101, memory 102 and other components, such as the I/O device 104 and firmware 105. The I/O devices 104 may comprise a keyboard, mouse, network interface, a storage device, a camera, a blue-tooth device, and an antenna. The firmware 105 may store BIOS routines that the computing platform 10 executes during system startup in order to initialize the processors 101, chipset 103, and other components of the computing platform 10 and/or EFI routines to interface the firmware 105 with an operating system 1023 of the computer platform 10 and provide a standard environment for booting the operating system 1023.

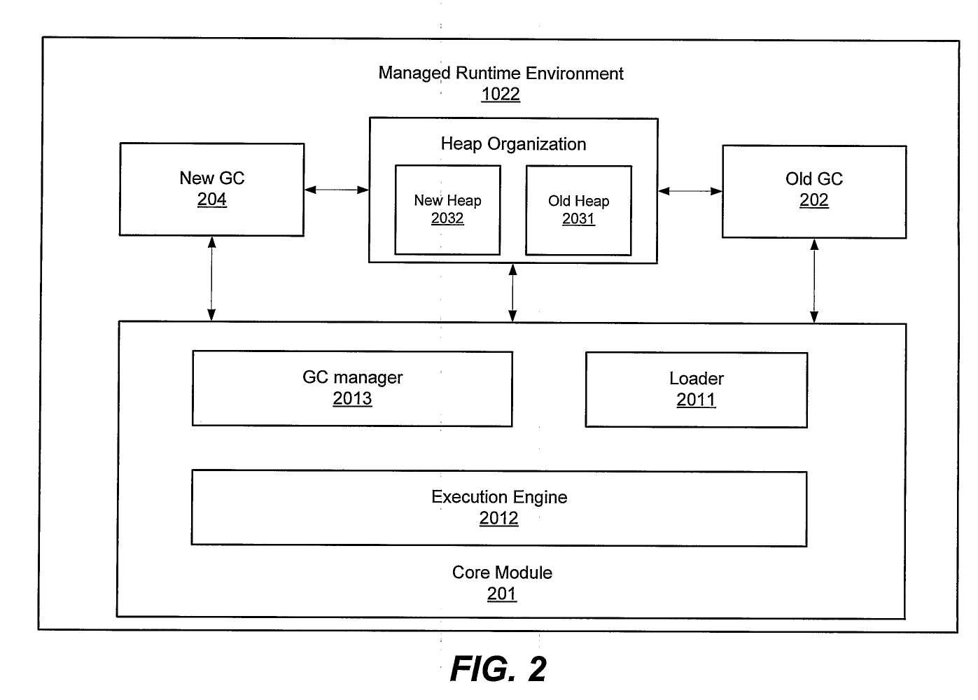

FIG. 2 shows an embodiment of the managed runtime system 1022. According to the embodiment, the multitasking virtual machine 1022 may comprise a core module 201, an old garbage collector 202, a heap organization 203, a new garbage collector 204, and possibly other components.

The core module 201 may be responsible for file loading, file execution, garbage collector management, and possibly other functionalities. The core module 201 may comprise a loader 201 1, an execution engine 2012 and a garbage collector manager 2013.

The loader 2011 may load files (including classes, interfaces, native methods) from various resources. For example, the loader 2011 may load the software application 1021, libraries and runtime environment variables from the managed runtime system vendor, programmer and any third parties. In the embodiment, the loader 2011 may further load garbage collectors in various ways. For example, the loader 2011 may load a garbage collector when starting up the system 1022, i.e., during an initialization stage of the system, or when the system 1022 really functions, i.e., during a runtime stage of the system. In another example, the loader 2011 may load the garbage collector as an executable binary file or a non-binary file (e.g., a JAVA class file). Examples of the loader 2011 may comprise class loaders, native method interface, and possibly other loading mechanisms.

The execution engine 2012 may execute the software application 1021 by utilizing the libraries, runtime environment variables and possibly other assistant data. More specifically, the execution engine 202 may translate the software application and execute the translated codes by utilizing the libraries, runtime environment variables and possibly other assistant data. Examples of the execution engine 2012 may comprise a JIT (just-in-time) compiler, an interpreter, a threading manager and possibly other components.

The garbage collector manager (GC manager) 2013 may be responsible for monitoring a garbage collector (e.g., an old garbage collector 202) that may currently manage a heap organization 203 according to a certain garbage collection algorithm, replacing the garbage collector with another garbage collector (e.g., a new garbage collector 204) that may manage the heap organization 203 according to another garbage collection algorithm and unloading the garbage collector if no longer needed.

The old garbage collector 202 may be responsible for managing the heap organization 203 according to an old garbage collection algorithm. For example, the old garbage collector 202 may perform memory allocation and memory reclamation (such as multi-blocks compaction, garbage reclamation, block defragmentation, reference patch, and so on) for the heap organization according to the old garbage collection algorithm. Examples of the old garbage collector may comprise a generational garbage collector, a semi-space garbage collector, and a mark-sweep garbage collector.

The new garbage collector 204 may be responsible for managing the heap organization 203 in place of the old garbage collector 203 according to a new garbage collection algorithm. For example, the new garbage collector 204 may perform memory allocation and memory reclamation (such as multi-blocks compaction, garbage reclamation, block defragmentation, reference patch, and so on) for the heap organization according to the new garbage collection algorithm. Examples of the new garbage collector 204 may comprise a generational garbage collector, a semispace garbage collector, and a mark-sweep garbage collector.

The old garbage collector 202 and the new garbage collector 204 may link with the core module 201 through individual application programming interfaces (API).

The heap organization 203 may be a memory structure to store data for the managed runtime system 1022. For example, the heap organization 203 may store program objects generated when executing a program and garbage collector data used to assist a garbage collector perform garbage collection. Size of the heap organization 203 may vary according to various factors, such as available memory size in the computing system, application memory requirement, and the algorithm design considerations.

The heap organization 203 may be divided into a number of separated heaps. Each heap may comprise a number of logically contiguous memory blocks, while no blocks overlap between two heaps. Different heaps may have different heap structures complying with different garbage collector algorithms. For example, the heap organization 203 may comprise an old heap 2031 complying with the old garbage collection algorithm and a new heap 2032 complying with the new garbage collection algorithm.

The garbage collector manager 2013 may monitor the performance of the old garbage collector 202 that may manage the heap organization 203 according to the old garbage collection algorithm during the runtime stage of the system 1022. Then, the loader 2011 may load a new garbage collector 204 into the system 1022 if the garbage collector manager 2013 or any other party (such as a user) decides to replace the old garbage collector 202 with the new garbage collector 204 to manage the heap organization 203 according to a new garbage collection algorithm.

The garbage collector manager 2013 may invoke the old garbage collector 202 to garbage collect the heap organization 203 and reclaim ‘dead’ objects from the heap organization 203 while keeping ‘live’ objects in the heap organization 203. The garbage collector-manager 2013 may transfer a part of the heap organization 203 from the old garbage collector 202 to the new garbage collector 204 for ‘live’ object migration before unloading the old garbage collector 202.

The reasons for the transferring may comprise that the heap structures for the old garbage collector 202 and the new garbage collector 204 are different and the ‘live’ objects should be migrated to comply with the new heap structure for the new garbage collector 204. As a result of the transferring, the old garbage collector 202 and new garbage collector 204 may manage different parts of the heap organization 203.

For example, the old garbage collector 202 may manage the old heap 2031 and the new garbage collector 204 may manage the new heap 2032. The ‘Live’ object migration may be implemented in two ways: moving the ‘live’ objects from the old heap 2031 into the new heap 2032 without changing the object layout; or, allocating new objects in the new heap 2032 and copy fields from the ‘live’ objects of the old heap into the new objects of the new heap.

After all of the ‘live’ objects are migrated into the new heap 2032, the garbage collector manager 2013 may unload the old garbage collector 202 from the managed runtime environment 1022, and transfer the old heap 2031 to the new garbage collector 204.

Other embodiments may implement other technologies for the structure of the managed runtime environment 1022. In an embodiment, the garbage collector manager 2013 may determine not to transfer a part of the heap organization 203 before unloading the old garbage collector 202. The reasons for not transferring may comprise that the heap structures of the old garbage collector 202 and the new garbage collector 204 may be the same or similar with each other, and therefore, there are no needs to move the ‘live’ objects. As a result of not transferring, the old garbage collector 202 and the new garbage collector 204 may manage a common part of the heap organization 203 before unloading the old garbage collector 203.

In another embodiment, the garbage collector manager 2013 may function as a garbage collector to manage a heap, e.g., a root heap (not shown in FIG. 2) of the heap organization 203, such as memory allocation and memory reclamation of the root heap. Since the garbage collector manager 2013 acts as a garbage collector, the core module 201 and the heap organization 203 may be enough to form a complete managed runtime system, even without the old garbage collector 202 and/or the new garbage collector 204.

Therefore, the old garbage collector 202 and/or the new garbage collector 204 may be loaded into the system 1022 as a user application, such as in form of JAVA class files or NET PE files. In such case, the garbage collector manager 2013 may allocate program objects generated when executing the loaded files of the old or new garbage collector into the root heap, and reclaim the program objects from the root heap when unloading the old or new garbage collector.

In yet another embodiment, the garbage collector manager 2013 may not unload the old garbage collector 202, but activate the new garbage collector 204 to manage the heap organization 203 with the old garbage collector 202. The combination of the old and new garbage collectors may be called as a hybrid garbage collection. For example, the old garbage collector 202 may be a semispace garbage collector and the new garbage collector 204 may be a generational garbage collector. Therefore, the hybrid garbage collector may be a generational/semispace garbage collector.

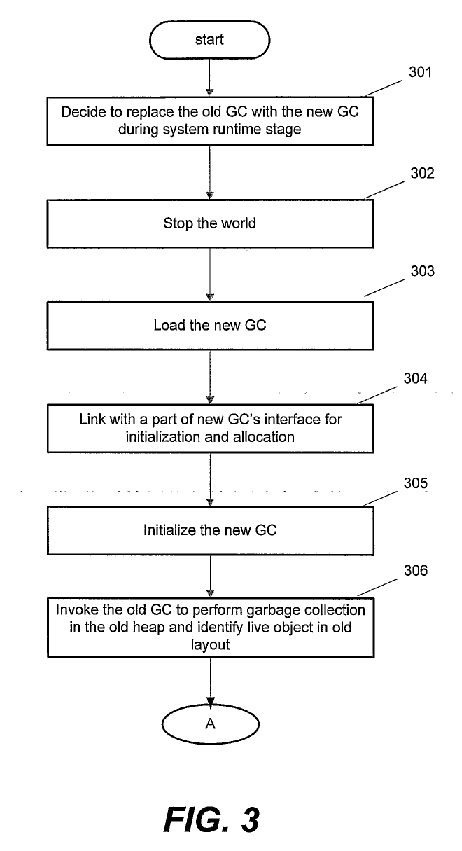

FIGS. 3-5 illustrate an embodiment of a method of dynamically changing an old garbage collector 202 in the managed runtime system 1022.

Referring to FIG. 3, in block 301, the garbage collector manager 2013 or any other party (e.g., the user) may decide to replace the old garbage collector 202 functioning according to the old garbage collection algorithm with the new garbage collector 204 functioning according to the new garbage collection algorithm during the system runtime stage. The garbage collection manager 2013 may make such decision according to various factors, such as characterizations of the applications running above the system 1022 and/or hardware (e.g., processor, memory, etc.) running under the system 1022. For example, performance of the software application SPECjbb2000 may be good with generational garbage collector when heap size is modest, but may be better with semi-space GC when heap size is large. The system runtime stage may comprise the stage that the system 1022 operates to finish an application execution.

In bock 302, the garbage collector manager 2013 may stop the world, for example, threads of the application running above the system 1022 may be suspended. In block 303, the loader 2011 may load the new garbage collector 204 into the system 1022. The loader 2011 may load the new garbage collector 204 in executable binary files. However, the loader 2011 may load the new garbage collator 204 in non-binary files, such as JAVA class files or CLI bytecode files. In such case, the garbage collector manager 2013 may load program objects representing the non-binary files of the new garbage collector 204 into the heap organization 203.

In block 304, the garbage collector manager 2013 may link a part or whole of the new garbage collector 204 by adhering to a part or whole of the API interface of the new garbage collector 204. For example, the garbage collector manager 2013 may link the initialization and allocation functions of the new garbage collector 204. Then, in block 305, the garbage collector manager 2013 may initialize the new garbage collector 204. In block 306, the garbage collector manager 2013 may invoke the old garbage collector 202 to perform a garbage collection by reclaiming the ‘dead’ objects from the heap organization 203 while keeping the ‘live’ objects in the heap organization 203. The ‘live’ objects may comprise the objects that may be reachable through a root reference stored in a root set, e.g., the objects referred by a root reference or another live object. The ‘dead’ objects may comprise the objects that may not be reachable through the root reference in the root set. The ‘live’ objects may be structured in an old layout that complies with the old garbage collection algorithm.

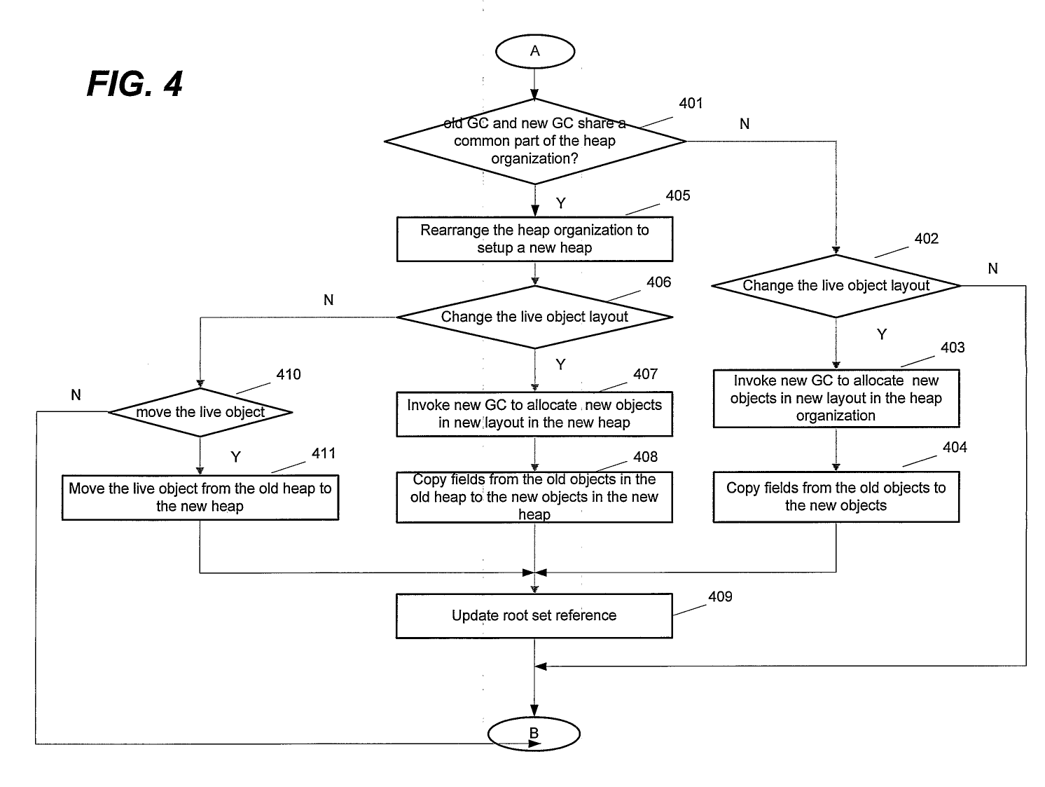

FIG. 4 continues to illustrate the embodiment of the method of changing the old garbage collector 202. In block 401, the garbage collector manager 2013 may determine whether the old garbage collector 202 and the new garbage collector 204 could share a common part of the heap organization 203. As described above, if the heap structure for the old garbage collector 202 is the same or similar with that for the new garbage collector 204, the two garbage collectors may share a common part of the heap organization 203. For example, if the old garbage collector 202 is a generational garbage collector with card table support and the new garbage collector 204 is a generational garbage collector with remember set support, the two garbage collectors may have the same heap structure, and therefore, may share the heap organization 203.

In another example, the old garbage collector is a semispace garbage collector that may require the heap organization 203 to be divided into two areas of equal space, i.e., from-space and to-space, and the new garbage collector is a generational garbage collector that may require the heap organization to be divided into two or more areas, each of which may serve one ‘generation’ of objects. In such case, the old garbage collector 202 and the new garbage collector 204 may have the similar heap structure and thus may share a common part of the heap organization 203, e.g., the from-space.

If both garbage collectors 202 and 204 share the common part of the heap organization 203, then in block 402, the garbage collector manager 2013 may determine whether to change the layout of the ‘live’ objects identified in block 306. Different garbage collection algorithms may have different requirements on object layouts. If the garbage collector manager 2013 determines to change the layout of the ‘live’ objects, then in block 403, the garbage collector manager 2013 may invoke the new garbage collector 204 to allocate new objects having the new object layout in the common part of the heap organization 203. The garbage collector manager 2013 may further invoke the old garbage collector 202 to find fields of the ‘live’ objects, invoke the new garbage collector 204 to find fields of the new objects, and copy values of the fields of the ‘live’ objects into the fields of the new objects in block 404.

Then, in block 409, the garbage collector manager 2013 may update the object references referring to the ‘live’ objects into the-object references referring to the new objects. For example, the new garbage collector 204 may provide the old garbage collector 202 with positions of the new objects so that the old garbage collector 204 may update the object references with the new object positions so that the object references may refer to the new objects.

However, if the garbage collector manager 2013 determines in block 401 that the heap structures for the both garbage collectors are different that they can not share the common part of the heap organization 203, the garbage collector manager 2013 may rearrange the heap organization 203 to transfer a part of the heap organization 203 to the new garbage collector 204 in block 405. More specifically, the heap organization 203 may be divided into two heaps, i.e., an old heap 2031 having a structure complying with the old garbage collector algorithm, and a new heap 2032 having a structure complying with the new garbage collector algorithm. For example, if the old garbage collector is a semispace garbage collector, and the new garbage collector is a mark-sweep collector, the garbage collector manager may rearrange the to-space complying with the mark-sweep algorithm while remaining the from-space complying with the semispace algorithm.

Then, in block 406, the garbage collector manager 2013 may determine whether to change the layout of the ‘live’ objects stored in the old heap 2031. If the garbage collector manager 2013 determines to change the layout of the ‘live’ objects, then in block 407, the garbage collector manager 2013 may invoke the new garbage collector 204 to allocate a new object in the new heap 2032. In block 408, the garbage collector manager 2013 may further invoke the old garbage collector 202 to find fields of the ‘live’ objects in the old heap 2031, invoke the new garbage collector 204 to find fields of the new objects in the new heap 2032, and copy values of the fields of the ‘live’ objects into the fields of the new objects. Then, in block 409, the garbage collector manager 2013 may update the object references that may refer to the ‘live’ objects in the old heap 2031 into the object references that may refer to the new objects in the new heap 2032.

However, if the garbage collector manager 2013 determines not to change the layout of the ‘live’ objects in block 406, then the garbage collector manager 2013 may determine whether to move the ‘live’ objects. Since the heap organization 203 has been rearranged into the old heap 2031 and the new heap 2032 that may be respectively managed by the old garbage collector 202 and the new garbage collector 204, there may exist needs to move the ‘live’ objects from the old heap 2031 into the new heap 2032.

If it is determined to move the ‘live’ objects, the garbage collector manager 2013 may invoke the new garbage collector 204 to move the ‘live’ objects from the old heap 2031 into the new heap 2032 in block 411. Then, in block 409, the garbage collector manager 2013 may update the object references that may refer to the ‘live’ objects in the old heap 2031 into the object references that may refer to the ‘live’ objects in the new heap 2032.

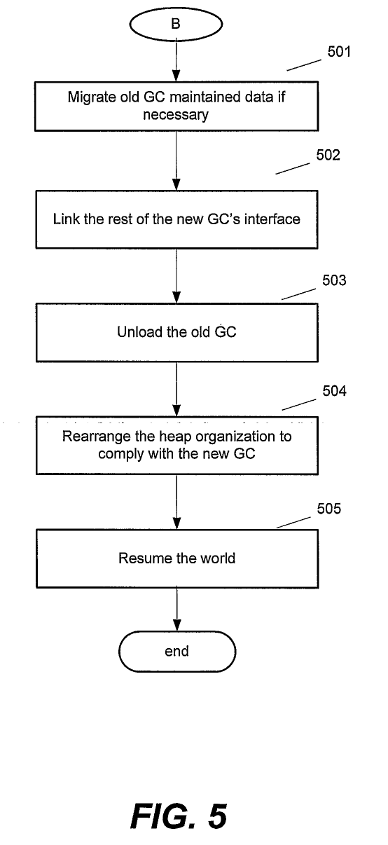

FIG. 5 continues to illustrate the embodiment of the method of changing the old garbage collector 202.

In block 501, the garbage collector manager 2013 may migrate garbage collector managed data within the heap organization 203 if necessary. The garbage collector managed data may be used by a garbage collector for memory management such as memory allocation and memory reclamation. The migration of the garbage collector managed data may comprise moving the garbage collector managed data and/or changing the layout of the garbage collector managed data. Under certain circumstances, the garbage collector managed data may be migrated, for example, if the heap organization is rearranged into the old heap 2031 and the new heap 2032, and/or if the layout of the garbage collector managed data for the old garbage collector 202 is different from that for the new garbage collector 204.

Then, the garbage collector manager 2013 may link the rest of the API interface of the new garbage collector 204 in block 502. In block 503, the garbage collector manager 2013 may unload the old garbage collector 202. For example, the garbage collector manager 2013 may unlink the API interface of the old garbage collector 202. If the old garbage collector 202 was loaded as a non-binary file into the system 1022, the garbage collector manager 2013 may reclaim program objects generated when executing the class file of the old garbage collector 202 from the heap organization 203.

In block 504, if the heap structure for the old garbage collector 202 is different from that for the new garbage collector 204, the new garbage collector 204 may rearrange the heap organization 203 into a heap structure complying with the new garbage collection algorithm. For example, the new garbage collector 204 may configure the old heap 2031 from an old heap structure into a new heap structure. However, block 504 may be omitted if the heap structures for the both garbage collectors are the same or similar.

Finally, in block 505, the garbage collector manager 2013 may resume the world, e.g., resume the application threads that were suspended in block 302.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. A method, comprising:
loading a first garbage collector into a managed runtime system during a runtime stage of the managed runtime system; and
activating the first garbage collector to manage a heap organization of the managed runtime system in place of a second garbage collector of the managed runtime system during the runtime stage.

2. The method of claim 1, wherein the first garbage collector is a non-binary file.

3. The method of claim 2, further comprising storing a program object generated when running the non-binary file of the first garbage collector into the heap organization.

4. The method of claim 1, further comprising unloading the second garbage collector from the managed runtime system.

5. The method of claim 4, wherein the activating further comprises:
invoking the second garbage collector to garbage collect the heap organization and to identify a live second object in a second part of the heap organization, wherein the second part of the heap organization complies with a second garbage collection algorithm of the second garbage collector; and
configuring a first part of the heap organization to comply with a first garbage collection algorithm of the first garbage collector.

6. The method of claim 5, wherein the activating further comprises:
moving the live second object from the second part of the heap organization to the first part of the heap organization; and
editing a reference referring to the live second object in the second part of the heap organization to another reference referring to the live second object in the first part of the heap organization.

7. The method of claim 5, wherein the activating further comprises:
allocating a first object in the first part of the heap organization, wherein the first object has a first layout complying with the first garbage collection algorithm and the live second object has a second layout complying with the second garbage collection algorithm;
copying data from the live second object into the first object;
editing a first reference referring to the live second object in the second part of the heap organization to a second reference referring to the first object in the first part of the heap organization; and
releasing the live second object from the second part of the heap organization.

8. The method of claim 5, wherein the activating further comprises:
configuring the second part of the heap organization to comply with a first garbage collection algorithm of the first garbage collector.

9. The method of claim 4, wherein the activating further comprises:
invoking the second garbage collector to garbage collect the heap organization and to identify a live second object in the heap organization, wherein the live second object has a second layout complying with a second garbage collection algorithm of the second garbage collector;
allocating a first object in the heap organization, wherein the first object has a first layout complying with the first garbage collection algorithm of the first garbage collector;
copying data from the live second object into the first object;
editing a reference referring to the live second object to another reference referring to the first object; and
releasing the live second object from the heap organization.

10. A method, comprising:
loading a first garbage collector into a managed runtime system during a runtime stage of the managed runtime system; and
activating the first garbage collector to manage a heap organization of the managed runtime system with a second garbage collector of the managed runtime system during the runtime stage.

11. The method of claim 10, wherein the activating further comprises:
configuring the heap organization to comply with a hybrid garbage collection algorithm of the first garbage collector and the second garbage collector.

12. The method of claim 11, wherein the activating further comprises:
invoking the second garbage collector to garbage collect the heap organization and identify a live second object in the heap organization;
allocating a hybrid object which has a hybrid layout complying with the hybrid garbage collection algorithm;
copying data from the live second object to the hybrid object; and
releasing the live second object from the heap organization.

13. A managed runtime system, comprising:
a heap organization;
a first garbage collector to manage the heap organization;
a loader to load a second garbage collector during a runtime stage of the managed runtime system; and
a garbage collector manager to activate the second garbage collector to manage the heap organization in place of the first garbage collector during the runtime stage.

14. The managed runtime system of claim 13, wherein the loader further loads the second garbage collector as a non-binary file, and the garbage collector manager further allocates a program object generated when running the non-binary file of the second garbage collector into the heap organization.

15. The managed runtime system of claim 13, wherein the garbage collector manager further unloads the first garbage collector from the managed runtime system.

16. The managed runtime system of claim 15, wherein the garbage collector manager further:
invokes the first garbage collector to garbage collect the heap organization and to identify a live first object in a first part of the heap organization, wherein the first part of the heap organization complies with a first garbage collection algorithm of the first garbage collector; and
configures a second part of the heap organization to comply with a second garbage collection algorithm of the second garbage collector.

17. The managed runtime system of claim 16, wherein the garbage collector manager further:
moves the live first object from the first part of the heap organization to the second part of the heap organization; and
edits a reference referring to the live first object in the first part of the heap organization to another reference referring to the live first object in the second part of the heap organization.

18. The managed runtime system of claim 16, wherein the garbage collector manager further:
allocates a second object in the second part of the heap organization, wherein the second object has a second layout complying with the second garbage collection algorithm and the live first object has a first layout complying with the first garbage collector algorithm;
copies data from the live first object into the second object;
edits a reference referring to the live first object in the first part of the heap organization to another reference referring to the second object in the second part of the heap organization; and
releases the live first object from the first part of the heap organization.

19. The managed runtime system of claim 16, wherein the garbage collector manager further configures the first part of the heap organization to comply with the second garbage collection algorithm.

20. The managed runtime system of claim 15, wherein the garbage collector manager further:
invokes the first garbage collector to garbage collect the heap organization and to identify a live first object in the heap organization, wherein the live first object has a first layout complying with a first garbage collection algorithm of the first garbage collector;
allocates a second object in the heap organization, wherein the second object has a second layout complying with a second garbage collection algorithm of the second garbage collector;
copies data from the live first object into the second object;
edits a reference referring to the live first object to another reference referring to the second object; and
releases the live first object from the heap organization.

21. A managed runtime system, comprising:
a heap organization;
a first garbage collector to manage the heap organization;
a loader to load a second garbage collector during a runtime stage of the managed runtime system; and
a garbage collector manager to activate the second garbage collector to manage the heap organization with the first garbage collector during the runtime stage.

22. The managed runtime system of claim 21, wherein the garbage collector manager further configures the heap organization to comply with a hybrid garbage collection algorithm of the first garbage collector and second garbage collector.

23. The managed runtime system of claim 21, wherein the garbage collector manager further:
invokes the first garbage collector to garbage collect the heap organization and to identify a live first object in the heap organization;
allocates a hybrid object which has a hybrid layout complying with a hybrid garbage collection algorithm of the first garbage collector and second garbage collector;
copies data from the live first object to the hybrid object; and
releases the live first object from the heap organization.

24. A machine-readable medium comprising a plurality of instructions which when executed result in a managed runtime system:
loading a garbage collector as a non-binary file into the managed runtime system during a runtime stage of the managed runtime system; and
allocating a program object generated when running the non-binary file of the garbage collector into a heap organization of the managed runtime system.

25. The machine-readable medium of claim 24, wherein the non-binary file is a JAVA class file.

26. The machine-readable medium of claim 24, wherein the plurality of instructions further result in the managed runtime system:
unloading the garbage collector from the managed runtime system; and
reclaiming the program object from the heap organization.
